(19) United States
(12) Patent Application Publication
(10) Pub. No.: US 2014/0136524 A1
(43) Pub. Date: May 15, 2014

(54) Method And System For Displaying Commodity Search Results

(71) Applicant: TENCENT TECHNOLOGY (SHENZHEN) COMPANY LIMITED, Shenzhen (CN)

(72) Inventors: Xiaofei LIU, Shenzhen (CN); Junyu LIU, Shenzhen (CN); Yaohua TAN, Shenzhen (CN); Yuanhong LIU, Shenzhen (CN)

(73) Assignee: TENCENT TECHNOLOGY (SHENZHEN) COMPANY LIMITED, Shenzhen (CN)

(21) Appl. No.: 14/160,152

(22) Filed: Jan. 21, 2014

Related U.S. Application Data
(63) Continuation of application No. PCT/CN2012/076996, filed on Jun. 15, 2012.

(30) Foreign Application Priority Data
Jul. 21, 2011 (CN) 201110205665.2

(51) Int. Cl. G06F 17/30

(52) U.S. Cl. CPC G06F 17/30554
USPC 707/722

(57) ABSTRACT

A method and system for displaying commodity search results are provided. A commodity keyword input by a user may be received. A search may be executed based on the commodity keyword input by the user. A commodity list searched out may be obtained. Key attributes of all of the commodities in the commodity list may be extracted. Commodities with the same key attributes may be identified. The commodities with the same key attributes may be aggregated into one Standard Product Unit (SPU) product. The SPU product, which has aggregated the commodities with the same key attributes, may be displayed.

### CROSS-REFERENCE TO RELATED APPLICATIONS

This application is a U.S. continuation of International Application No. PCT/CN2012/076996, filed Jun. 15, 2012. This application claims the benefit and priority of Chinese Patent Application No. 201110205665.2, filed Jul. 21, 2011. The entire disclosures of each of the above applications are incorporated by reference.

### FIELD

The present disclosure relates to network technologies and to a method and system for displaying commodity search results.

### BACKGROUND

This section provides background information related to the present disclosure which is not necessarily prior art.

Many existing consumer to consumer (C2C) platforms have provided search functions, which may obtain a commodity list related to a commodity keyword, and display the obtained commodity list for a user, based on the commodity keyword input by the user. However, existing displaying modes are relatively mixed and disorderly. Commodities with the same attributes may generally be spread across multiple pages, which is very inconvenient for a user to browse and search for commodities.

### SUMMARY

This section provides a general summary of the disclosure, and is not a comprehensive disclosure of its full scope or all of its features.

Various embodiments provide a method and system for displaying commodity search results.

A method for displaying commodity search results, includes:

receiving a commodity keyword input by a user;

searching based on the commodity keyword input by the user;

obtaining a commodity list searched out;

extracting key attributes about each commodity in the commodity list,

identifying commodities with the same key attributes;

aggregating the commodities with the same key attributes into one Standard Product Unit (SPU) product; and

displaying the SPU product, which has aggregated the commodities with the same key attributes.

A system for displaying commodity search results, includes a searching module, an aggregating module and a displaying module, in which

the searching module is configured to receive a commodity keyword input by a user, search based on the commodity keyword input by the user, and obtain a commodity list searched out;

the aggregating module is configured to extract key attributes about each commodity in the commodity list, identify commodities with the same key attributes, and aggregate the commodities with the same key attributes into one SPU product; and

the displaying module is configured to display the SPU product, which has aggregated the commodities with the same key attributes.

A system for displaying commodity search results, includes a server and a client, in which the server includes a first memory, a first processor in communication with the first memory, and a first interface, the first memory stores a searching instruction and an aggregating instruction, which are executable by the first processor;

in which the client includes a second memory, a second processor in communication with the second memory, and a second interface, the second memory stores a displaying instruction, which is executable by the second processor;

the searching instruction instructs to receive a commodity keyword input by a user via the first interface, searches based on the commodity keyword input by the user, and obtains a commodity list searched out;

the aggregating instruction instructs to extract key attributes about each commodity in the commodity list, identifies commodities with the same key attributes, and aggregates the commodities with the same key attributes into one Standard Product Unit (SPU) product; and

the displaying instruction instructs to display the SPU product via the second interface, which has aggregated the commodities with the same key attributes.

Based on the foregoing method and system for displaying commodity search results, a search may be executed based on a commodity keyword input by a user. After obtaining a commodity list searched out, commodities with the same key attributes may be aggregated into one SPU product. Subsequently, the SPU product, which has aggregated the commodities with the same key attributes may be displayed. Since the displayed SPU product has aggregated the commodities with the same key attributes, the displayed SPU product will not be mixed and disorderly, so that users may find it more convenient to browse and search for commodity search results.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Various embodiments will be described in the following accompanying with attached figures, such that one having ordinary skill in the art may understand the foregoing and other features as well as advantages of the present disclosure.

FIG. 1 is a flowchart illustrating a method for displaying commodity search results, in accordance with various embodiments.

FIG. 2 is a diagram illustrating a page for displaying an SPU product, which has aggregated commodities with the same key attributes, in accordance with various embodiments.

FIG. 3 is a diagram illustrating a page for displaying commodities with the same key attributes, in which the commodities have been aggregated into an SPU product, in accordance with various embodiments.

FIG. 4 is a block diagram illustrating structure of a system for displaying commodity search results, in accordance with various embodiments.

FIG. 5 is a block diagram illustrating another structure of a system for displaying commodity search results, in accordance with various embodiments.

FIG. 6 is a diagram illustrating still another structure of a system for displaying commodity search results, in accordance with various embodiments.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

Various embodiments provide a scheme for displaying commodity search results, which receives a commodity keyword input by a user, search based on the commodity keyword input by the user, obtains a commodity list searched out; extracts key attributes about all of the commodities in the commodity list, identifies commodities with the same key attributes, aggregate the commodities with the same key attributes into an SPU product, and displays the SPU product, which has aggregated the commodities with the same key attributes.

To make technical solutions of the present disclosure more clear, detailed descriptions about technical solutions of the present disclosure will be further provided in the following, accompanying with attached figures and examples.

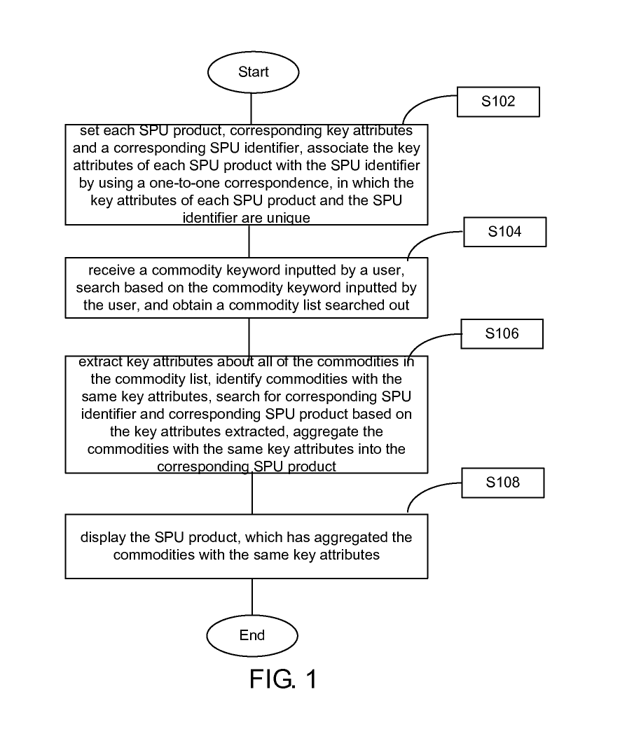

As shown in FIG. 1, in one embodiment, a method for displaying commodity search results may include the following blocks.

In block S102, set each Standard Product Unit (SPU) product, corresponding key attributes and a corresponding SPU identifier, associate the key attributes of each SPU product with the SPU identifier by using a one-to-one correspondence, in which the key attributes of each SPU product and the SPU identifier are unique.

The SPU is a standardized product unit. An SPU identifier is to uniquely identify an SPU. For example, a device of a particular type may be defined as an SPU. In one embodiment, unique key attribute may be set based on commodity type. For example, commodity model may be set as the key attributes of a commodity. Alternatively, the combination of commodity brand and commodity model may be set as the key attributes of the commodity. Each SPU product, SPU identifier, and corresponding key attributes set may be stored in a database of a server side.

In block S104, receive a commodity keyword input by a user, search based on the commodity keyword input by the user, and obtain a commodity list searched out.

Search by utilizing search functions provided by a network platform. A search engine may search in a commodity database at a server side, based on the commodity keyword input by the user, and return the commodity list searched out. For example, when a user inputs the name of a certain commodity into a C2C platform, a list of all of the commodities related to the commodity name may be obtained. The commodity list may include commodity name, commodity model, advertising slogan, merchants offer, sales volume, and so on.

In block S106, extract the key attributes of all of the commodities in the commodity list, identify commodities with the same key attributes, search for corresponding SPU identifier and corresponding SPU product based on the extracted key attributes, aggregate the commodities with the same key attributes into a corresponding SPU product.

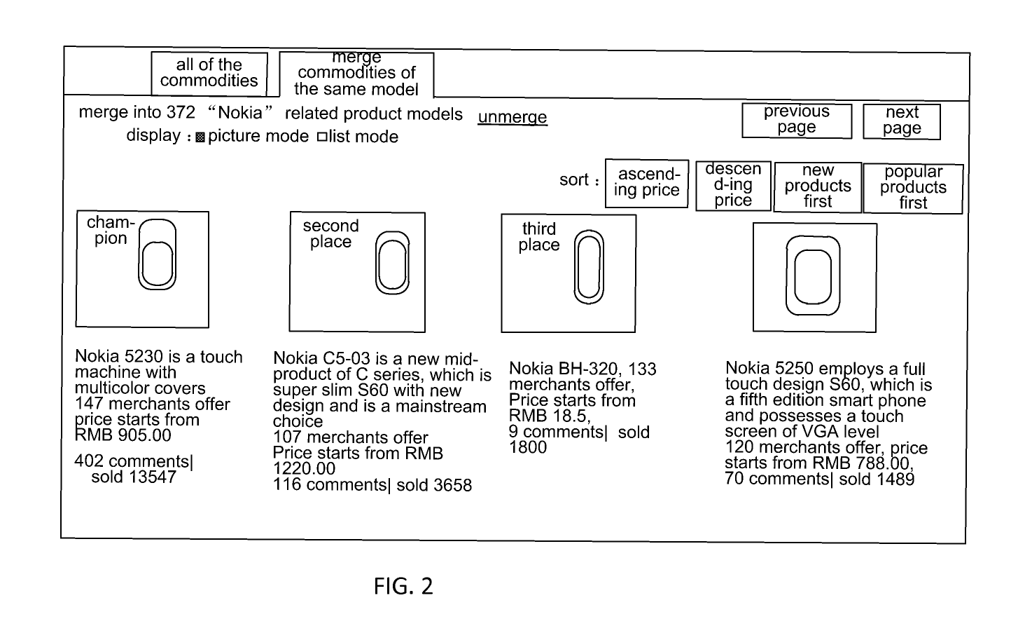

In various embodiments, as shown in FIG. 2, after obtaining the commodity list searched out, display the commodity list on a displaying screen of a client. Set a control of “merge commodities of the same model” at a client. After receiving a clicking operation on the control from a user, the client may proceed with block S106.

In block S108, display the SPU product, which has aggregated the commodities with the same key attributes.

In various embodiments, as shown in FIG. 2, after aggregating the commodities with the same key attributes into a corresponding SPU product at a server side, take various SPU products corresponding to all of the commodities searched out as search results, and display the search results on the displaying screen of the client.

In various embodiments, a user may click the displayed SPU product. After receiving the clicking operation on the SPU product, the client may display all of the commodities with the same key attributes, which have been aggregated into the SPU product. As shown in FIG. 2, the client may receive the clicking operation on the SPU product of “Nokia 5230”, and display all of the commodities with the same key attributes, which have been aggregated into Nokia 5230.

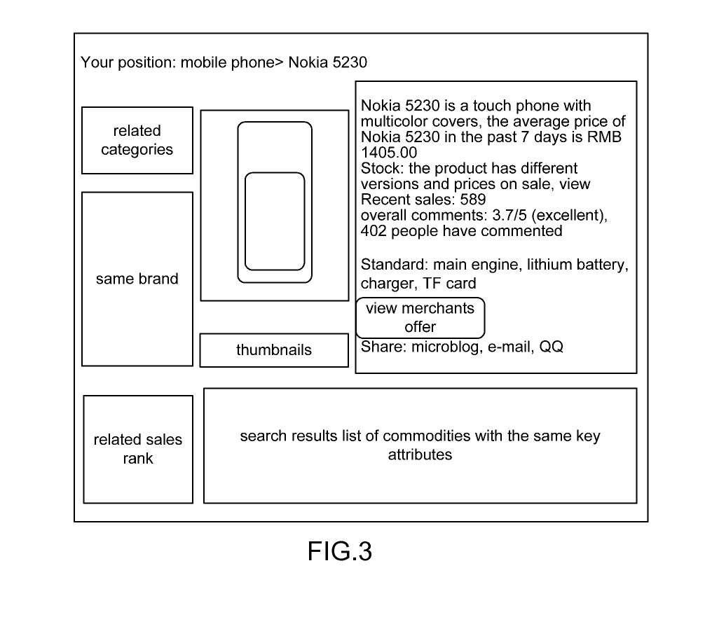

As shown in FIG. 3, click and enter the SPU product of “Nokia 5230”. Some related information about the SPU product may be displayed on a page, e.g., picture, thumbnail, stock, recent sales volume about the SPU product, and so on. Meanwhile, display other information on the page, such as related category, the same brand, related sales rank of the SPU product, and so on. Search results list of aggregated commodities with the same key attributes may also be displayed. The user may view a detailed commodity list by entering the SPU product.

Since commodities with the same key attributes have been aggregated into one SPU product, that is, the commodities with the same key attributes have been aggregated into the same page. Each page corresponds to one SPU product. After the commodities with the same key attributes have been aggregated, each SPU product may be displayed. Compared to a traditional mode listing all of the commodities searched out, the displaying mode in the example may classify and integrate cluttered commodities that users may find convenient to view and browse.

In addition, since a link address of a page located by the commodities with the same key attributes has been established on the SPU product, when clicking the SPU product, a user may enter a page displaying a list of commodities with the same key commodities that the user further finds convenient to view and browse.

In various embodiments, the foregoing method may also include the following blocks: make a statistic on associated data about commodities with the same key attributes in the SPU product, add the associated data to a corresponding SPU product, and display the associated data in the SPU product on a displaying screen.

As shown in FIG. 2, in the C2C platform, after inputting a keyword “Nokia mobile phone”, a user may obtain a commodity list of the Nokia mobile phone. The commodity list may include information about the Nokia mobile phone, such as model, parameters, performance, advertising slogan, price, merchants, picture, and so on. The user may click the button of “merge commodities of the same model” on the page, perform a merge operation on all of the provided commodity lists, and then commodities with the same model (that is, the key attribute is model) may be aggregated into one SPU product. The SPU product has aggregated all of the Nokia mobile phones of the same model.

In various embodiments, make a statistic on the associated data of commodities with the same key attributes in the SPU product. The associated data may be the following information about a commodity, such as number of comments, sales volume, merchant number of offer, the lowest price, and so on. When displaying each SPU product, display each SPU product together with the associated data on the displaying screen. As shown in FIG. 2, the SPU product is Nokia 5230, display the associated data of “147 merchants offer, 402 comments, price starts from RMB 905.00, sold 13547”, such that users may find it convenient to intuitively view the general information of a certain commodity.

In various embodiments, the foregoing method may also include the following blocks. Receive a clicking operation on the associated data, and enter a page related with the associated data. After making a statistic on the associated data of commodities with the same key attributes in the SPU product, integrate the same associated data into one page, display locations of the associated data on the SPU product. Establish a link address of a page located by the associated data. Thus, after clicking the associated data displayed on the SPU product, the user may enter the page related with the associated data, and view the specific contents of the associated data. For example, as shown in FIG. 2, the user clicks “402 comments in total”, and enters a page displaying all of the comment contents about the commodity. That is, the user may view the detailed contents about the commodity comments.

In various embodiments, the foregoing method may also include the following blocks. Sort the displayed SPU products based on the associated data, in which each displayed SPU product has aggregated commodities with the same key attributes. In various embodiments, on the page displaying each SPU product, controls of different kinds of associated data may also be set. A user may select type of associated data used for sorting by clicking a control. As shown in FIG. 2, the sorting may be executed based on price or sales volume that users may find convenient to search for and browse.

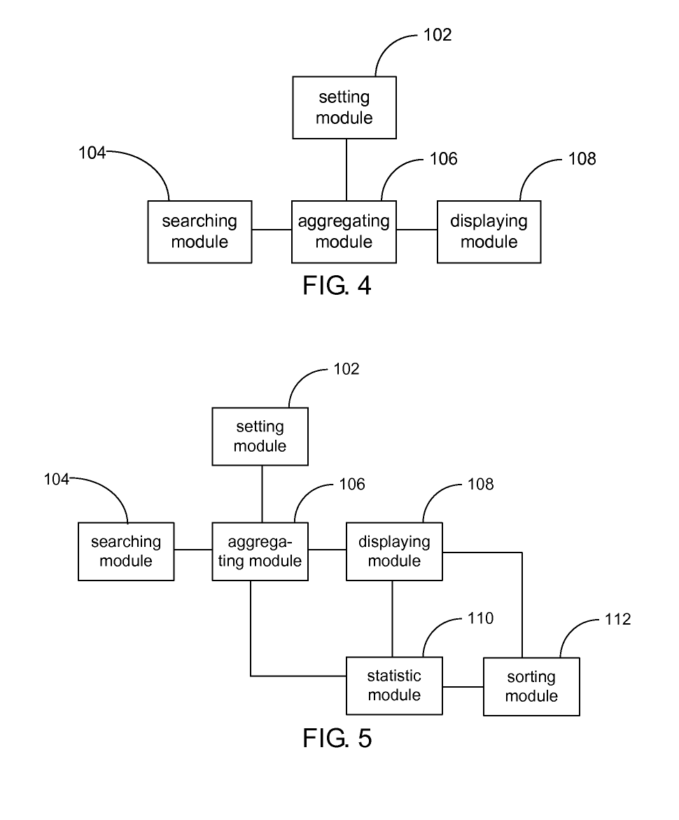

As shown in FIG. 4, in various embodiments, a system for displaying commodity search results may include a searching module 104, an aggregating module 106, a displaying module 108, and may further include a setting module 102.

The setting module 102 sets each SPU product, corresponding key attributes and corresponding SPU identifier, associates the key attributes of each SPU product with corresponding SPU identifier by using a one-to-one correspondence. The key attributes of each SPU product and SPU identifier are unique.

The SPU is a standardized product unit. The SPU identifier uniquely identifies an SPU. For example, a device of a particular model may be defined as an SPU. In various embodiments, the setting module 102 is located on the server side. The setting module 102 may set unique key attributes based on commodity type. For example, the setting module 102 may set the commodity model as key attributes of the commodity. Alternatively, the setting module 102 may also set the combination of commodity brand and commodity model as the key attributes of the commodity. Each SPU product, corresponding SPU identifier and corresponding key attributes set are stored in a database of the server side (not shown in the figure).

The searching module 104 receives a commodity keyword input by a user, searches based on the commodity keyword input by the user, and obtains a commodity list searched out.

The searching module 104 may be located on the server side. The searching module 104 may search based on search functions provided by a network platform. The search engine may search in a commodity database at the server side (not shown in the figure), based on the commodity keyword input by the user, and return a commodity list searched out. For example, after inputting a certain commodity name into the C2C platform, a user may obtain a commodity list carrying all of the commodities related to the commodity name. The commodity list may include information, such as name, model, advertising slogan, merchants offer, sales volume of the commodity, and so on.

The aggregating module 106 extracts the key attributes of all of the commodities in the commodity list, identifies commodities with the same key attributes, and aggregates the commodities with the same key attributes into one SPU product. That is, search for corresponding SPU identifier and SPU product, based on the extracted key attributes, and aggregate the commodities with the same key attributes into a corresponding SPU product.

In various embodiments, as shown in FIG. 2, after obtaining the commodity list searched out, the commodity list may be displayed on a displaying screen of the client. A control of “merge commodities of the same model” may also be set in the client. The aggregating module 106 may perform an aggregation process, after receiving the clicking operation on the control from a user.

The displaying module 108 displays the SPU product, which has aggregated the commodities with the same key attributes.

In various embodiments, as shown in FIG. 2, at the server side, after the aggregating module 106 aggregates the commodities with the same key attributes into a corresponding SPU product, the displaying module 108, which is located on the client, may take various SPU products corresponding to all of the commodities searched out as search results, and display the search results on the displaying screen.

In various embodiments, a user may perform a clicking operation on the displayed SPU product. The displaying module 108 further receives the clicking operation on the SPU product, and displays all of the commodities with the same key attributes, which have been aggregated into the SPU product. As shown in FIG. 2, the displaying module 108 may receive the clicking operation on the SPU product of “Nokia 5230”, and display all of the commodities with the same key attributes, which have been aggregated into Nokia 5230 (as shown in FIG. 3).

Since all of the commodities with the same key attributes have been aggregated into one SPU product, all of the commodities with the same key attributes have been aggregated into one page. Each page may correspond to one SPU product. After aggregating commodities with the same key attributes, each SPU product may be displayed. Compared with a traditional mode, that is, list all of the commodities searched out, by displaying each SPU product in the various embodiments, mixed and disorderly commodities may be classified and integrated, so that users may find it convenient to view and browse.

In addition, a link address of a page located by commodities with the same key attributes may be established on the SPU product. After clicking on the SPU product, a user may enter a page, which displays a commodity list of the commodities with the same key attributes, that users may find convenient to view and browse.

In various embodiments, as shown in FIG. 5, the system for displaying commodity search results may include the foregoing setting module 102, searching module 104, aggregating module 106 and displaying module 108, and may further include a statistic module 110 and a sorting module 112.

The statistic module 110 makes a statistic on associated data of commodities with the same key attributes in the SPU product.

In various embodiments, the displaying module 108 further displays the associated data in the SPU product on the displaying screen.

The associated data may include the following information about a commodity, such as number of comments, sales volume, merchant number of offer, the lowest price, and so on. When displaying each SPU product, the associated data may also be displayed together with the each SPU product. As shown in FIG. 2, the SPU product may be Nokia 5230. Display the associated data of “147 merchants offer, 402 comments in total, price starts from RMB 905.00, sold 13547”, such that users may intuitively view the general information about a particular commodity.

In various embodiments, the displaying module 108 further receives a clicking operation on the associated data, and enters a page related to the associated data.

After making a statistic on the associated data about commodities with the same key attributes in the SPU product, integrate the same associated data into one page. Display location of the associated data on the SPU product, and establish a link address about a page located by the associated data on the SPU product. Thus, after clicking the associated data displayed on the SPU product, a user may enter a page related to the associated data, and view detailed contents of the associated data. For example, as shown in FIG. 2, after clicking on “402 comments in total”, a user may enter a page displaying all of the comment contents about the commodity. That is, the user may browse the detailed contents about the commodity comment.

The sorting module 112 sorts displayed SPU products, each of which has aggregated commodities with the same key attributes, based on the associated data.

In various embodiments, controls of different kinds of associated data may also be set on the page displaying each SPU product. A user may select type of the associated data used for sorting by clicking on a control. As shown in FIG. 2, the sorting may be executed based on price or sales volume, so that users may find it convenient to search for and browse.

The technical solutions provided by various embodiments may be implemented by hardware, software, and firmware, or any combination thereof. When being implemented with software, these functions may be stored into a computer readable medium, or may be transmitted to the computer readable medium in the manner of one or more instructions or in the manner of code. The computer readable medium may include a computer storage medium, and a communication medium, which may enable a computer program to be transferred from one place to another place. The storage medium may be an available medium, which may be accessed by any general or special computer.

For example, such computer readable medium may include, but is not limited to Random Access Memory (RAM), Read-Only Memory (ROM), Electrically Erasable Programmable Read-Only Memory (EEPROM), Compact Disk (CD)-ROM, or other CD storage, disc storage, magnetic disk storage, or other magnetic storage device, or any other program code medium, which may be used for bearing or storing instructions or data structures, or program codes of other formats readable by general or special computer, or readable by general or special processor. In addition, any link may be appropriately defined as the computer readable medium. The disk and magnetic disk may include a compact magnetic disk, a laser disk, a CD, a Digital Versatile Disc (DVD), a floppy disk, or a blu-ray disk. The magnetic disk may generally copy data with magnetic performance, while disc may generally copy data optically with laser.

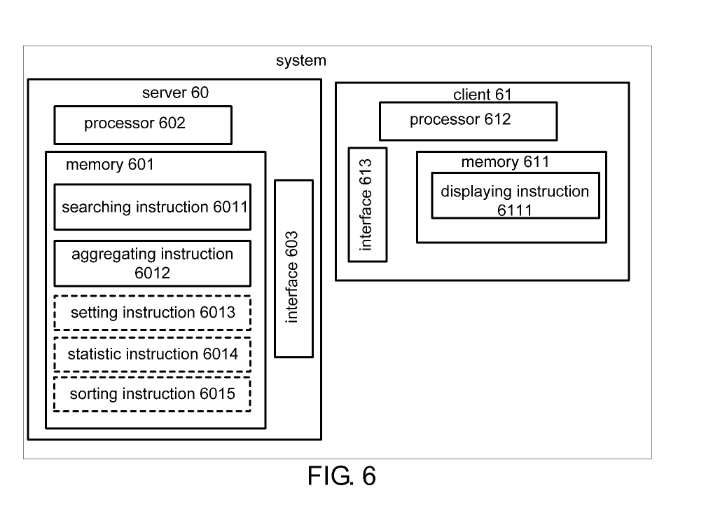

For example, FIG. 6 is a schematic diagram illustrating still another structure of a system for displaying commodity search results, in accordance with various embodiments.

As shown in FIG. 6, the system may include a server 60 and a client 61. The server 60 may include a memory 601, a processor 602 in communication with the memory 601 and an interface 603. The memory 601 may store a searching instruction 6011 and an aggregating instruction 6012, which are executable by the processor 602. The memory 601 may further store a setting instruction 6013 executable by the processor 602.

The client 61 may include a memory 611, a processor 612 in communication with the memory 611, and an interface 613. The memory 611 may store a displaying instruction 6111, which is executable by the processor 612.

The setting instruction 6013 may indicate to set each SPU product, corresponding key attributes and a corresponding SPU identifier, associate the key attributes of each SPU product with the corresponding SPU identifier by using a one-to-one correspondence. The key attributes of each SPU product and the SPU identifier are unique.

The server 60 may further include a database 604 (which is not shown in the figure). The database 604 may be set within the memory 601 or outside of the memory 601.

The setting instruction 6013 may instruct to set unique key attributes based on commodity type. Each SPU product, corresponding SPU identifier and corresponding key attributes set are stored in the database 604 of the server 60.

The searching instruction 6011 may instruct to receive a commodity keyword input by a user via the interface 603, search based on the commodity keyword input by the user, and obtain a commodity list searched out.

The searching instruction 6011 may instruct to search based on search functions provided by a network platform.

Based on the searching instruction 6011, a search engine may search in the database 604 at the server 60, based on the commodity keyword input by the user, and return a commodity list searched out.

The aggregating instruction 6012 may instruct to extract the key attributes about all of the commodities in the commodity list, identify commodities with the same key attributes, and aggregate the commodities with the same key attributes into one SPU product.

The displaying instruction 6111 instructs to display the SPU product via the interface 613, which has aggregated the commodities with the same key attributes.

The memory 601 may further store a statistic instruction 6014 and a sorting instruction 6015, which are executable by the processor 602.

When being executed by the processor 602, functions implemented by the statistic instruction 6014 and the sorting instruction 6015 are the same as functions of the statistic module 110 and sorting module 112 in the example illustrated with FIG. 5, which will not be repeated here.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for displaying commodity search results, comprising:
receiving a commodity keyword input by a user;
searching based on the commodity keyword input by the user;
obtaining a commodity list searched out;
extracting key attributes of each commodity in the commodity list, identifying commodities with the same key attributes;
aggregating the commodities with the same key attributes into one Standard Product Unit (SPU) product; and
displaying the SPU product, which has aggregated the commodities with the same key attributes.

2. The method according to claim 1, further comprising:
before receiving the commodity keyword input by the user, setting each SPU product, corresponding key attributes and a corresponding SPU identifier, associating the key attributes of each SPU product with the corresponding SPU identifier by using a one-to-one correspondence, wherein the key attributes of each SPU product and the SPU identifier are unique;
wherein aggregating the commodities with the same key attributes into one SPU product comprises:
searching for the corresponding SPU identifier and the corresponding SPU product based on the key attributes extracted, and aggregating the commodities with the same key attributes into the corresponding SPU product.

3. The method according to claim 1, further comprising:
after displaying the SPU product, which has aggregated the commodities with the same key attributes, receiving a click operation on the SPU product, and displaying all of the commodities with the same key attributes, which have been aggregated into the SPU product.

4. The method according to claim 1, further comprising:
making a statistic on associated data of the commodities with the same key attributes in the SPU product;
adding the associated data to the corresponding SPU product; and
displaying the associated data in the SPU product on a displaying screen.

5. The method according to claim 4, further comprising:
receiving a click operation on the associated data, and entering a page related with the associated data.

6. The method according to claim 4, further comprising:
sorting displayed SPU products, each of which has aggregated the commodities with the same key attributes, based on the associated data.

7. A system for displaying commodity search results, comprising a searching module, an aggregating module and a displaying module, wherein the searching module is configured to receive a commodity keyword input by a user, search based on the commodity keyword input by the user, and obtain a commodity list searched out;
the aggregating module is configured to extract key attributes of each commodity in the commodity list, identify commodities with the same key attributes, and aggregate the commodities with the same key attributes into one Standard Product Unit (SPU) product; and
the displaying module is configured to display the SPU product, which has aggregated the commodities with the same key attributes.

8. The system according to claim 7, wherein the system further comprises a setting module, which is configured to set each SPU product, corresponding key attributes and a corresponding SPU identifier, associate the key attributes of each SPU product with the corresponding SPU identifier by using a one-to-one correspondence, wherein the key attributes of each SPU product and the SPU identifier are unique; and
the aggregating module is configured to search for the corresponding SPU identifier and the corresponding SPU product, based on the key attributes extracted, and aggregate the commodities with the same key attributes into the corresponding SPU product.

9. The system according to claim 7, wherein the displaying module is further configured to receive a click operation on the SPU product, and display the commodities with the same key attributes, which have been aggregated into the SPU product.

10. The system according to claim 7, wherein the system further comprises a statistic module, which is configured to make a statistic on associated data of the commodities with the same key attributes in the SPU product; and
the displaying module is further configured to display the associated data in the SPU product on a displaying screen.

11. The system according to claim 10, wherein the displaying module is further configured to receive the click operation on the associated data, and enter a page related to the associated data.

12. The system according to claim 10, wherein the system further comprises a sorting module, which is configured to sort SPU products displayed based on the associated data, each of the SPU products has aggregated the commodities with the same key attributes.

13. A system for displaying commodity search results, comprising a server and a client, wherein the server comprises a first memory, a first processor in communication with the first memory, and a first interface, the first memory stores a searching instruction and an aggregating instruction, which are executable by the first processor;
wherein the client comprises a second memory, a second processor in communication with the second memory, and a second interface, the second memory stores a displaying instruction, which is executable by the second processor;
the searching instruction instructs to receive a commodity keyword input by a user via the first interface, search based on the commodity keyword input by the user, and obtain a commodity list searched out;
the aggregating instruction instructs to extract key attributes of each commodity in the commodity list, identify commodities with the same key attributes, and aggregate the commodities with the same key attributes into one Standard Product Unit (SPU) product; and
the displaying instruction instructs to display the SPU product via the second interface, which has aggregated the commodities with the same key attributes.

14. The system according to claim 13, wherein the first memory further stores a setting instruction executable by the first processor, the setting instruction instructs to set each SPU product, corresponding key attributes and a corresponding SPU identifier, associate the key attributes of each SPU product with the corresponding SPU identifier by using a one-to-one correspondence, wherein the key attributes of each SPU product and the SPU identifier are unique; and
the aggregating instruction instructs to search for the corresponding SPU identifier and the corresponding SPU product, based on the key attributes extracted, and aggregate the commodities with the same key attributes into the corresponding SPU product.

15. The system according to claim 13, wherein the displaying instruction further instructs to receive a click operation on the SPU product, and display the commodities with the same key attributes via the second interface, which have been aggregated into the SPU product.

16. The system according to claim 13, wherein the first memory further stores a statistic instruction executable by the first processor, the statistic instruction instructs to make a statistic on associated data of the commodities with the same key attributes in the SPU product; and
the displaying instruction further instructs to display the associated data in the SPU product via the second interface.

17. The system according to claim 16, wherein the displaying instruction further instructs to receive the click operation on the associated data, and enter a page related to the associated data.

18. The system according to claim 16, wherein the first memory further stores a sorting instruction executable by the first processor, the sorting instruction instructs to sort SPU products displayed based on the associated data, each of the SPU products has aggregated the commodities with the same key attributes.

19. The system according to claim 14, wherein the server further comprises a database, which stores each SPU product, the corresponding SPU identifier and the corresponding key attributes set based on the setting instruction.
